(19) United States
(12) Patent Application Publication
(10) Pub. No.: US 2015/0286400 A1
(43) Pub. Date: Oct. 8, 2015

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Ken Nakamura, Hachioji-shi (JP)

(21) Appl. No.: 14/677,518

(22) Filed: Apr. 2, 2015

(30) Foreign Application Priority Data
Apr. 4, 2014 (JP) 2014-078211

(51) Int. Cl. G06F 3/0488; G06F 3/041

(52) U.S. Cl. CPC G06F 3/04883; G06F 3/041

(57) ABSTRACT

An information processing apparatus includes a detection unit configured to detect an operation position and an operation type of an operation performed in a display screen, and a control unit configured to display a magnified display region, which is obtained by magnifying a predetermined display region containing the operation position, based on the operation position and the operation type detected by the detection unit, and to execute, without switching the display screen, a change of a magnitude of the magnified display region, which is being displayed, or a change of a magnification ratio of screen information displayed in the magnified display region.

### BACKGROUND OF THE INVENTION

1. Field of the Invention

The present disclosure generally relates to image processing and, more particularly to an information processing apparatus, control method, storage medium, and to a screen display control technique for an information processing apparatus equipped with a touch panel capable of magnifying and displaying a part of the display screen.

2. Description of the Related Art

Information processing apparatuses that are equipped with a touch panel and are able to be operated by the user touching a display screen of the touch panel with a finger or a pen are in common use. The touch panel is an input device that outputs coordinates corresponding to the position that the user's finger or pen has contacted. The information processing apparatus is able to detect operations performed on the touch panel, such as touch-down, touch-on, move, touch-up, touch-off, and multi-touch, to perform a predetermined action.

The term “touch-down” means that the finger or pen has touched the touch panel. The term “touch-on” means that the finger or pen is in contact with the touch panel. The term “move” means that the finger or pen is moving while being in contact with the touch panel. The term “touch-up” means that the finger or pen, which has touched the touch panel, is separated from the touch panel. The term “touch-off” means that none is in contact with the touch panel. The term “multi-touch” means that the fingers or the like have simultaneously touched a plurality of points.

Furthermore, the information processing apparatus can detect other operations, such as pinch-in and pinch-out. The term “pinch-in” means such an operation that the user simultaneously uses two fingers, the index finger and thumb, to touch the touch panel and shortens the distance between two points in such a way as to pinch the surface of the touch panel. The term “pinch-out” means such an operation that the user lengthens the distance between two points.

Such an information processing apparatus can further display, on a display screen of the touch panel, various pieces of visible information, such as character strings, graphics, images, and operation buttons. However, if a number of pieces of visible information are displayed on the display screen, character strings, etc., displayed thereon become very small in size, so that the content thereof may become illegible. Therefore, the user may not reach the desired visible information.

There is also an issue specific to touch panels. For example, when the user presses a certain region on the touch panel with the finger, the finger used to press the region may overlap the region, thus hiding character strings, etc., displayed in the region. Furthermore, when the user presses a small region, it may become difficult to position the finger with respect to the desired region. Under these circumstances, in the case of conventional information processing apparatuses, the user may not perform an accurate operation on the touch panel.

To solve the above-mentioned issues, Japanese Patent Application Laid-Open No. 2012-178175 discusses a function called a “magnifying glass”. The magnifying glass is a function of magnifying and displaying, at a predetermined magnification, the content of a predetermined region of the display screen on another window, which is separately provided on the display screen and is smaller in size than the display screen.

Furthermore, Japanese Patent Application Laid-Open No. 2012-521048 discusses a function of moving a magnifying glass, which is discussed in Japanese Patent Application Laid-Open No. 2012-178175, while causing the magnifying glass to follow “move”.

In an operation using the function of the magnifying glass, to change the magnification ratio of the magnifying glass or the size of the magnifying glass itself, it is necessary to perform a change operation on a setting screen, which is displayed differently from a display screen displaying the magnifying glass. Thus, every time the user changes the magnification ratio of the magnifying glass or the size of the magnifying glass itself, the user will need to perform transition of display screens. Therefore, the user may not immediately confirm the content of changes.

Moreover, the user will need to perform an additional operation for switching settings of the magnifying glass. Therefore, the operability may be decreased.

### SUMMARY OF THE INVENTION

The present disclosure is directed to an information processing apparatus capable of allowing the user to intuitively and instantaneously perform an operation for magnifying and displaying in a display screen.

According to an aspect of the present disclosure, an information processing apparatus includes a detection unit configured to detect an operation position and an operation type of an operation performed in a display screen, and a control unit configured to display a magnified display region, which is obtained by magnifying a predetermined display region containing the operation position, based on the operation position and the operation type detected by the detection unit, and to execute, without switching the display screen, a change of a magnitude of the magnified display region, which is being displayed, or a change of a magnification ratio of screen information displayed in the magnified display region.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of an information processing apparatus according to a first exemplary embodiment.

FIG. 2 is a block diagram illustrating a functional configuration of the information processing apparatus according to the first exemplary embodiment.

FIG. 3 is a flowchart illustrating a procedure of processing performed when input information is received.

FIG. 4 is a flowchart illustrating a procedure of processing for displaying a magnifying glass.

FIGS. 5A, 5B, and 5C illustrate operations of displaying and moving the magnifying glass displayed on a display.

FIG. 6 is a flowchart illustrating processing for operating the magnifying glass by pinch or move.

FIGS. 7A and 7B illustrate operations of changing the magnification ratio of the magnifying glass.

FIGS. 8A, 8B, 8C, and 8D illustrate operations of changing the magnitude of the magnifying glass.

FIGS. 9A and 9B illustrate operations of displaying the magnifying glass.

FIG. 10 is a flowchart illustrating a procedure of processing for hiding the magnifying glass.

FIG. 11 illustrates the concept of calculation used for displaying the magnifying glass.

FIG. 12 is a flowchart illustrating a procedure of processing for changing the magnification ratio of the magnifying glass according to a second exemplary embodiment.

### DESCRIPTION OF THE EMBODIMENTS

Various exemplary embodiments, features, and aspects of the disclosure will be described in detail below with reference to the drawings. In the following exemplary embodiments, an example of an information processing apparatus having a display screen the size of which is small as compared with the stationary type apparatus, such as a mobile terminal or a business machine, is described. The information processing apparatus is able to display, on the display screen, a magnified display region, which is a region corresponding to the above-mentioned magnifying glass. Thus, in the context of the present specification, the magnified display region is referred to as a “magnifying glass”.

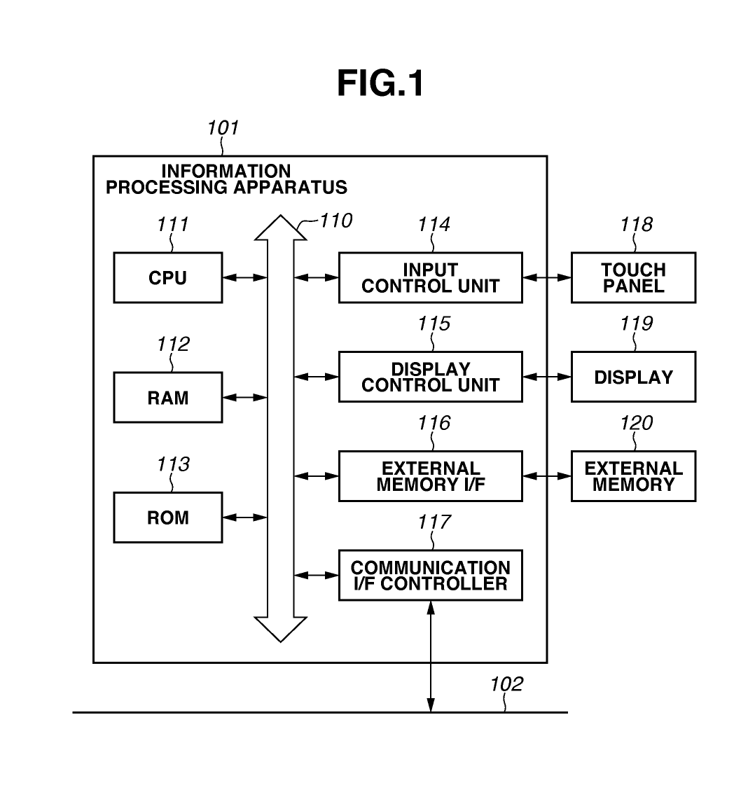

FIG. 1 is a block diagram illustrating a hardware configuration of an information processing apparatus 101 according to a first exemplary embodiment. The information processing apparatus 101 includes a central processing unit (CPU) 111, a random access memory (RAM) 112, and a read-only memory (ROM) 113, which are connected to a system bus 110. The information processing apparatus 101 further includes an input control unit 114, a display control unit 115, an external memory interface (I/F) 116, and a communication I/F controller 117, which are also connected to the system bus 110. These units 111 to 117 can exchange data between each other via the system bus 110. As used herein, the term “unit” generally refers to any combination of software, firmware, hardware, or other component, such as circuitry, that is used to effectuate a purpose.

The CPU 111 controls operations of the information processing apparatus 101 by executing computer programs. The CPU 111 further implements functions of the information processing apparatus 101, the configuration of which is described below. The RAM 112, which is a volatile memory, is used as a temporary storage region, such as a main memory or a work memory, for the CPU 111. The ROM 113 is a non-volatile memory. The ROM 113 stores data, such as image data, and various computer programs, based on which the CPU 111 operates, in respective predetermined regions. The image data is data used to generate an image serving as screen information to be displayed on a display 119.

A touch panel 118, a keyboard (not illustrated), and a mouse (not illustrated), which are input devices, are connected to the input control unit 114. The input control unit 114 generates input information indicating a user's operation position and a user's operation type received by an input device, and notifies the CPU 111 of the input information.

The display 119, which is a display device, is connected to the display control unit 115. The display control unit 115 causes the display 119 to display a graphical user interface (GUI) screen, which constitutes a GUI, based on a display control signal supplied from the CPU 111.

In the present exemplary embodiment, the touch panel 118 and the display 119 are integrated as a unit. More specifically, the touch panel 118 is configured to have such a light transmittance as not to hinder displaying by the display 119, and is mounted on an upper layer of the display surface of the display 119. This configuration enables the input coordinates on the touch panel 118 and the display coordinates on the display 119 to be associated with each other in a one-to-one relationship. Therefore, such a GUI as if the user is able to directly operate the display screen of the display 119 can be formed.

In addition, the touch panel 118 may be of the resistive film type, the electrostatic capacitance type, the surface acoustic wave type, the infrared ray type, the electromagnetic induction type, the image recognition type, or the photo-sensor type.

An external memory 120 is connected to the external memory I/F 116. The external memory 120 is, for example, a hard disk, a compact disc read-only memory (CD-ROM), a digital versatile disc (DVD), or a memory card. The external memory I/F 116 performs reading of data from the mounted external memory 120 and writing of data to the external memory 120 under the control of the CPU 111.

The communication I/F control unit 117 performs various communications with a network 102, such as a local area network (LAN), the Internet, a wired communication, and a wireless communication.

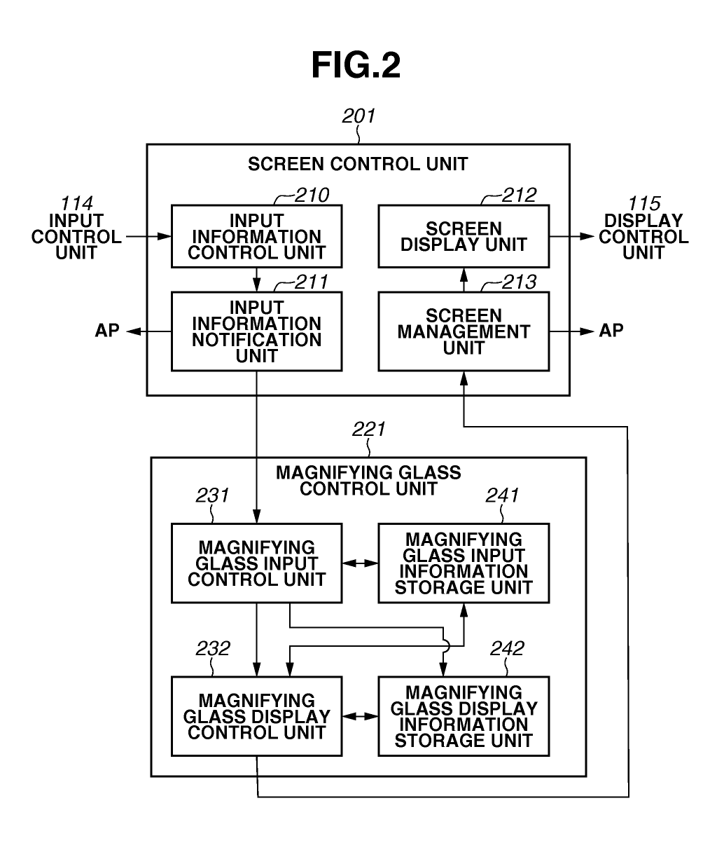

FIG. 2 is a block diagram illustrating a functional configuration of the information processing apparatus 101. The information processing apparatus 101 allows the CPU 111 to execute computer programs to establish functions of a screen control unit 201 and a magnifying glass control unit 221 as illustrated in FIG. 2.

The screen control unit 201 includes detailed functions of an input information control unit 210, an input information notification unit 211, a screen display unit 212, and a screen management unit 213. The magnifying glass control unit 221 includes detailed functions of a magnifying glass input control unit 231, a magnifying glass display control unit 232, a magnifying glass input information storage unit 241, and a magnifying glass display information storage unit 242.

The input information control unit 210 operates as a detection unit configured to detect a display state of the touch panel 118 and an operation position and an operation type of an operation performed by the user on the display screen of the touch panel 118 (the display 119). More specifically, the input information control unit 210 converts the operation position of an operation performed on the touch panel 118 into logical data that is able to be handled by the information processing apparatus 101, i.e., an x coordinate, a y coordinate, and changed values thereof. Furthermore, the input information control unit 210 detects operation types, such as the above-mentioned touch-down, touch-on, move, touch-up, and touch-off, by comparing the operation position and a changed value thereof with a predetermined condition.

The term “predetermined condition” means, for example, an operation pattern for discriminating characteristics of an operation. A change in time is also included in the predetermined condition. In other words, a state in which no operation is performed within a constant period is also one of operation types. Furthermore, movement information (movement direction, movement amount, and movement speed) of the finger or pen moving on the surface of the touch panel 118 is also one of operation types. Therefore, the input information control unit 210 is also able to detect the movement direction during move. In that case, the input information control unit 210 detects the movement direction for each of a vertical component and a horizontal component on the touch panel 118 based on a change in coordinates of the touch position.

Furthermore, the input information control unit 210 is able to simultaneously detect positions (coordinates) of touch-on and move. For example, the input information control unit 210 is able to detect an operation of moving the fingers from the state of touch-on of two points in such a way as to shorten or lengthen the distance information (for example, an interval) between the two points with respect to the direction of a line segment connecting the positions of the two points. Such an operation is called “pinch”. The input information control unit 210 determines, as pinch, a state in which each of or one of the two points has moved, and detects the coordinates of the middle point of a line segment connecting the two points and the distance information between the two points.

The input information control unit 210 notifies the input information notification unit 211 of input information indicating the detected operation position and operation type.

The input information notification unit 211 notifies one or more pieces of application software (hereinafter referred to as “AP”) operating on the information processing apparatus 101 of the input information of which the input information control unit 210 has notified the input information notification unit 211. In this instance, the input information notification unit 211 may notify all of the APs of the input information, or may notify a specific AP of the input information. Alternatively, the input information notification unit 211 may notify only an AP that has issued a demand for receiving the notification.

The image display unit 212 outputs information of the display screen to the display 119 via the display control unit 115 in response to a request from the screen management unit 213. The screen management unit 213 stores screen information of one or more APs. Furthermore, when receiving a request for switching screens, the screen management unit 213 shifts the designated screen to the foreground. Moreover, when a screen lying at the foreground has been hidden based on a management structure for screens, the screen management unit 213 shifts the appropriate screen, normally, an immediately preceding screen, to the foreground. For example, the screen management unit 213 can display a magnifying glass, which is described below, at the foreground, or can shift an immediately preceding screen to the foreground when the magnifying glass is hidden. In addition, the screen management unit 213 notifies an AP of a request for re-drawing a screen, which is likely to occur due to the execution of processing associated with a switching request for screens, and causes the AP to update the screen. The screen management unit 213 makes a request for displaying the screen to the screen display unit 212.

The magnifying glass control unit 221 functions as a control unit configured to perform control over displaying of the magnifying glass in conjunction with the screen control unit 201. More specifically, the magnifying glass control unit 221 independently controls displaying, non-displaying (hiding), and changing of the magnifying glass on the touch panel 118 (the display 119) according to the operation position and the operation type detected by the input information control unit 210. The term “changing” means changing of the magnification ratio of screen information displayed in the magnifying glass, changing of the magnitude of the magnifying glass itself, or changing of the position of the magnification glass.

The magnifying glass input control unit 231 stores the input information received from the input information notification unit 211, as information indicating the visible state of the current display screen, into the magnifying glass input information storage unit 241. Furthermore, the magnifying glass input control unit 231 performs the following operations according to the operation position and the operation type indicated by the input information:
The magnifying glass input control unit 231 specifies a display region containing the operation position, in other words, a region serving as a magnification source in the display screen.
The magnifying glass input control unit 231 calculates the magnitude of the magnifying glass (the size of a magnified display region).
The magnifying glass input control unit 231 calculates a region in which to display the magnifying glass. In this instance, the magnifying glass input control unit 231 performs association with a display region of the magnification source in such a way as to prevent the entire display region of the magnification source from being hidden by the magnifying glass or to prevent the region on which the magnifying glass is displayed from making it unclear which portion is the magnification source. The association is performed using an image display connecting the region on which the magnifying glass is displayed and the display region serving as a magnification source.
The magnifying glass input control unit 231 stores information of the calculated region into the magnifying glass display information storage unit 242.
The magnifying glass input control unit 231 issues, to the magnifying glass display control unit 232, notifications including a request for displaying or re-displaying the magnifying glass.

The magnifying glass display control unit 232 performs the following control operations according to the operation position and the operation type indicated by the input information:
The magnifying glass display control unit 232 changes a magnification ratio of screen information to be displayed on the magnifying glass.
The magnifying glass display control unit 232 requests the screen management unit 213 to update a screen used to display the magnifying glass.
The magnifying glass display control unit 232 compares the operation type detected by the input information control unit 210 with a predetermined condition for displaying the magnifying glass (hereinafter referred to as a “display condition”), and determines whether the operation type satisfies the display condition.
The magnifying glass display control unit 232 compares the operation type detected by the input information control unit 210 with a predetermined condition for hiding (not displaying) the magnifying glass (hereinafter referred to as a “hiding condition”), and determines whether the operation type satisfies the hiding condition.

Each of the display condition and the hiding condition is one of conditions for performing display control over the magnifying glass. The display condition is satisfied if, for example, any one of the following operations is performed:
The detected operation type is a long press (touch-on continuing for a predetermined time or more). Thus, if the detected operation type is an operation in which the same operation continues for a predetermined time (a long press), it is determined that the display condition is satisfied.
The detected operation type is a double tap (touch-on being detected twice within a predetermined time).
A specific input key is pressed in the information processing apparatus 101 irrespective of the detected operation type.

The hiding condition is satisfied if, for example, any one of the following operations is performed:
The detected operation type is touch-up, and a specified time, for example, 5 seconds, has elapsed after touch-up. The specified time may be zero seconds.
A specific input key is pressed in the information processing apparatus 101.

The latest input information is stored in the magnifying glass input information storage unit 241. For example, when the user “touches on” a certain position (coordinates x and y) on the touch panel 118, information indicating x, y, and touch-on is stored in the magnifying glass input information storage unit 241.

The magnifying glass display information storage unit 242 stores the following information:
Magnification ratio of the magnifying glass.
Information indicating the magnitude of the magnifying glass itself.
Information indicating a state as to whether the magnifying glass is output (visible state).
Information about the coordinates and magnitude of the magnifying glass and a region at which a press is detected.

More specifically, the initial values of information about the magnification ratio and the magnitude of the magnifying glass itself may be fixed values, values input by the user via the touch panel 118, or values designated by the AP. In other words, these pieces of information are not limited to the specific ones described in the present exemplary embodiment.

Furthermore, each of the magnifying glass input control unit 231 and the magnifying glass display control unit 232 is a function associated with the control over the magnifying glass, and these units may be implemented in the form of a single functional module. In the following description, in a case where it is not necessary to discriminate between these units, the operation is described as an operation of the magnifying glass control unit 221.

[Manners of Use]

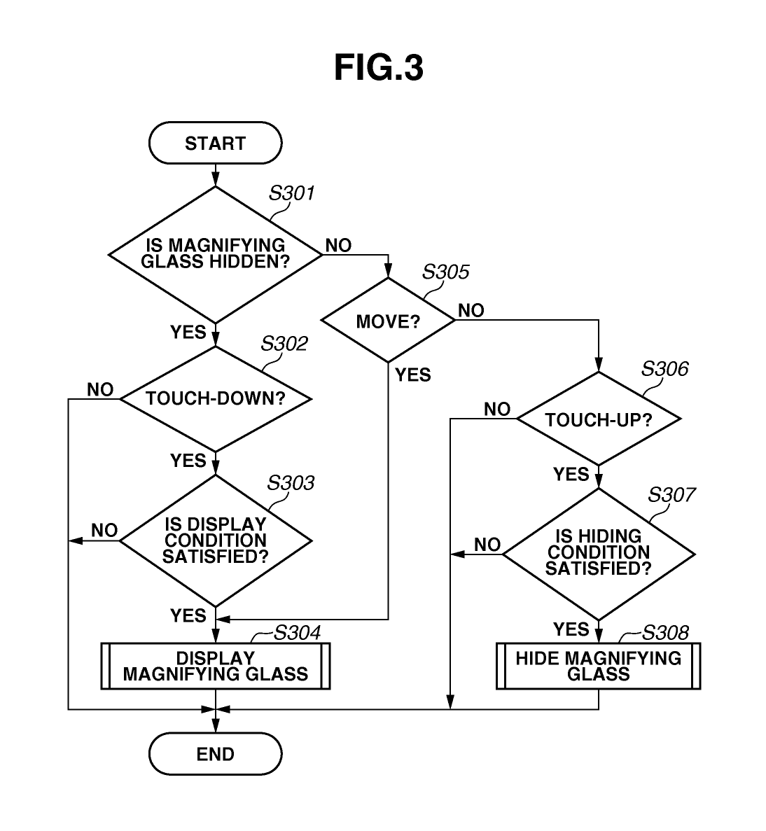

Next, examples of manners of use of the information processing apparatus 101 according to the present exemplary embodiment are described with reference to FIGS. 3 to 11. FIG. 3 is a flowchart illustrating a procedure of processing for displaying or hiding the magnifying glass. This processing (control) is executed mainly by the magnifying glass control unit 221.

In step S301, the magnifying glass control unit 221 determines a current visible state of the magnifying glass in a display screen based on information stored in the magnifying glass input information storage unit 241. If the magnifying glass is hidden (is not displayed) (YES in step S301), the magnifying glass control unit 221 determines whether to display the magnifying glass by comparing the operation type detected by the input information control unit 210 with a predetermined condition. For example, in step S302, the magnifying glass control unit 221 determines whether the detected operation type is touch-down. If the operation type is touch-down (YES in step S302), then in step S303, the magnifying glass control unit 221 determines whether the display condition for the magnifying glass is satisfied. If the display condition is satisfied (YES in step S303), then in step S304, the magnifying glass control unit 221 performs magnifying glass display processing. The magnifying glass display processing (step S304) is described below.

If, in step S302, the operation type is not touch-down (NO in step S302), or if, in step S303, the display condition is not satisfied (NO in step S303), the processing ends.

On the other hand, if, in step S301, the magnifying glass is not hidden, in other words, the magnifying glass is in the process of being displayed (NO in step S301), then in step S305, the magnifying glass control unit 221 determines whether the operation type is move. If the operation type is move (YES in step S305), then, the processing proceeds to the magnifying glass display processing (step S304). Thus, the magnifying glass control unit 221 continues displaying the magnifying glass. In this case, screen information displayed in the magnifying glass is screen information obtained in the move destination. If the operation type is not move (NOT in step S305), then in step S306, the magnifying glass control unit 221 determines whether the operation type is touch-up. If the operation type is touch-up (YES in step S306), then in step S307, the magnifying glass control unit 221 determines whether the hiding condition is satisfied. If the hiding condition is satisfied (YES in step S307), then in step S308, the magnifying glass control unit 221 performs magnifying glass hiding processing. The magnifying glass hiding processing (step S308) is described below.

If, in step S306, the operation type is not touch-up (NO in step S306), or if, in step S307, the hiding condition is not satisfied (NO in step S307), the processing ends.

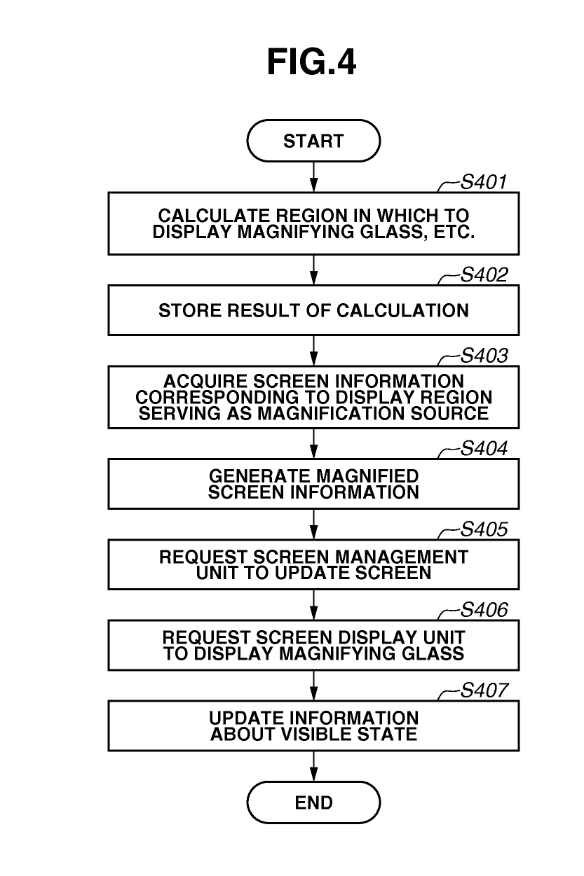

FIG. 4 is a flowchart illustrating a procedure of processing for displaying the magnifying glass. The processing for displaying the magnifying glass is executed by the magnifying glass control unit 221.

In step S401, the magnifying glass control unit 221 calculates the magnitude of the magnifying glass and a region in which to display the magnifying glass. In step S402, the magnifying glass control unit 221 stores a result of the calculation. In step S403, the magnifying glass control unit 221 acquires screen information corresponding to a display region, serving as a magnification source, having a horizontal width and a vertical width from the coordinates of the display screen on the foreground AP managed by the screen management unit 213. Then, in step S404, the magnifying glass control unit 221 generates magnified screen information obtained by magnifying the acquired screen information at a magnification ratio (an initial value), and associates the magnified screen information with the magnifying glass. In step S405, the magnifying glass control unit 221 requests the screen management unit 213 to update a screen in such a way as to display the magnifying glass together with the magnified screen information. In step S406, the screen management unit 213 requests the screen display unit 212 to display the magnifying glass while displaying a part of the display region at the foreground of the screen of the AP being displayed.

In step S407, the magnifying glass control unit 221 determines that the magnifying glass is in the process of being displayed, and updates information indicating the immediately preceding visible state.

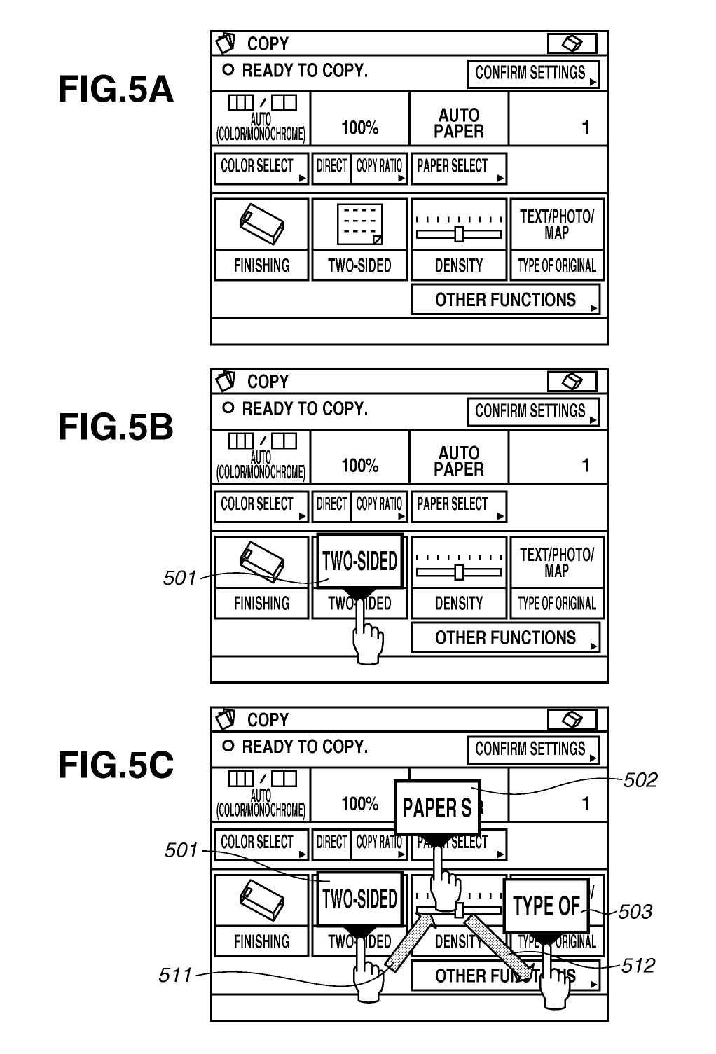

Display examples of the magnifying glass being displayed on the display 119 according to the above-described processing are illustrated in FIGS. 5A, 5B, and 5C. FIG. 5A illustrates an example in which a display screen provided by an AP that is running on the information processing apparatus 101 is displayed on the display 119. FIG. 5B illustrates an example in which the user has performed an operation on the touch panel 118 in the state illustrated in FIG. 5A. In the example illustrated in FIG. 5B, a button image region containing letters “TWO-SIDED” is specified as a display region containing an operation position. This display region serves as a magnification source. Screen information of the display region is magnified and displayed by a magnifying glass 501. In this instance, a part of the display region, serving as a magnification source, is also displayed, and a leader image, which establishes a connection between the displayed part of the display region and the magnifying glass 501, is also displayed to associate the display region with the magnifying glass 501.

FIG. 5C illustrates an example in which the user has performed move 511 in the state illustrated in FIG. 5B. This example of processing is to move the magnifying glass as a result of processing performed in step S305 illustrated in FIG. 3. In the example illustrated in FIG. 5C, move 511 is performed from the button image region containing letters “TWO-SIDED” to a button image region containing letters “PAPER SELECT”, and a part of the button image region containing letters “PAPER SELECT” is magnified and displayed in a magnifying glass 502. After that, move 512 is performed to a button image region containing “TYPE OF ORIGINAL”, and a part of the button image region containing “TYPE OF ORIGINAL” is magnified and displayed in a magnifying glass 503. Thus, the magnifying glass control unit 221 successively displays the magnifying glasses 501, 502, and 503 as movement destinations without switching display screens.

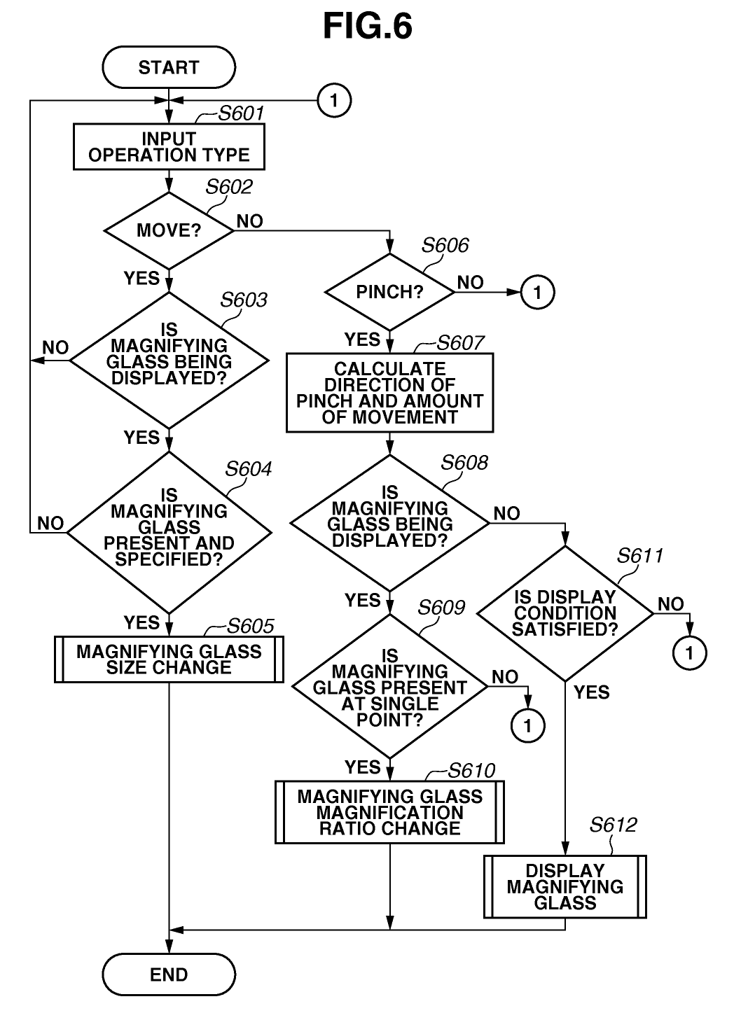

FIG. 6 is a flowchart illustrating a procedure of processing for changing the magnifying glass. This processing is executed by the magnifying glass control unit 221. In step S601, the magnifying glass control unit 221 detects input information indicating an operation position and an operation type, and then in step S602, the magnifying glass control unit 221 determines whether the operation type is move. If the operation type is move (YES in step S602), then in step S603, the magnifying glass control unit 221 determines whether a magnifying glass is being displayed. If the magnifying glass is being displayed (YES in step S603), then in step S604, the magnifying glass control unit 221 determines whether a magnifying glass is present and specified at a position serving as a destination of move. The magnifying glass control unit 221 can determine whether a magnifying glass is present and specified at a position serving as a destination of move by comparing coordinates of magnifying glasses stored in the magnifying glass display information storage unit 242 with the coordinates of the move destination. If one of operation positions lies inside a magnifying glass, the magnifying glass control unit 221 determines that the magnifying glass is specified.

If a magnifying glass is present and specified (YES in step S604), the processing proceeds to magnifying glass size change processing (step S605).

In the magnifying glass size change processing (step S605), the magnifying glass control unit 221 calculates the magnitude of the magnifying glass itself based on the direction of move and the amount of movement thereof, and stores a result of the calculation into the magnifying glass display information storage unit 242. Then, the magnifying glass control unit 221 requests the screen management unit 213 to update the screen regarding the magnifying glass based on information stored in the magnifying glass display information storage unit 242. Then, the processing ends. The calculation of the magnitude of the magnifying glass itself is described below.

If, in step S603, the magnifying glass is not being displayed (NO in step S603), or if, in step S604, any magnifying glass is not specified (NO in step S604), the processing returns to step S601.

On the other hand, if, in step S602, the operation type is not move (NO in step S602), then in step S606, the magnifying glass control unit 221 determines whether the operation type is pinch. If the operation type is pinch (YES in step S606), then in step S607, the magnifying glass control unit 221 calculates the direction of pinch and the amount of movement thereof. The amount of movement is a value indicating how much the distance between two points designated on the touch panel 118 has changed.

Then, in step S608, the magnifying glass control unit 221 determines whether the magnifying glass is being displayed based on information indicating the visible state stored in the magnifying glass display information storage unit 242. If the magnifying glass is being displayed (YES in step S608), then in step S609, the magnifying glass control unit 221 determines whether a magnifying glass is present at the coordinates of any one (single point) of two points designated by pinch. The magnifying glass control unit 221 can determine whether a magnifying glass is present at a single point by comparing coordinates of magnifying glasses stored in the magnifying glass display information storage unit 242 with the coordinates of each of the two designated points. If a magnifying glass is present at a single point (YES in step S609), then in step S610, the processing proceeds to magnifying glass magnification ratio change processing (step S610).

In the magnifying glass magnification ratio change processing, the magnifying glass control unit 221 calculates a magnification ratio based on the direction of move and the amount of movement thereof, and stores the calculated magnification ratio into the magnifying glass display information storage unit 242. Then, the magnifying glass control unit 221 requests the screen management unit 213 to update the screen regarding the magnifying glass based on information stored in the magnifying glass display information storage unit 242. Then, the processing ends. The calculation of a magnification ratio is described below.

In, in step S608, the magnifying glass is not being displayed (NO in step S608), then in step S611, the magnifying glass control unit 221 determines whether the display condition for the magnifying glass is satisfied. If the display condition is satisfied (YES in step S611), the processing proceeds to magnifying glass display processing (step S612).

In the magnifying glass display processing, the magnifying glass control unit 221 calculates the magnitude of the magnifying glass itself, and stores a result of the calculation into the magnifying glass display information storage unit 242. Then, the magnifying glass control unit 221 requests the screen management unit 213 to update the screen regarding the magnifying glass based on information stored in the magnifying glass display information storage unit 242. Then, the processing ends. The calculation of the magnitude of the magnifying glass itself is described below.

If, in step S606, the operation type is not pinch (NO in step S606), the processing returns to step S601. If, in step S609, any magnifying glass is not present at a single point (NO in step S609), or if, in step S611, the display condition for the magnifying glass is not satisfied (NO in step S611), the processing also returns to step S601.

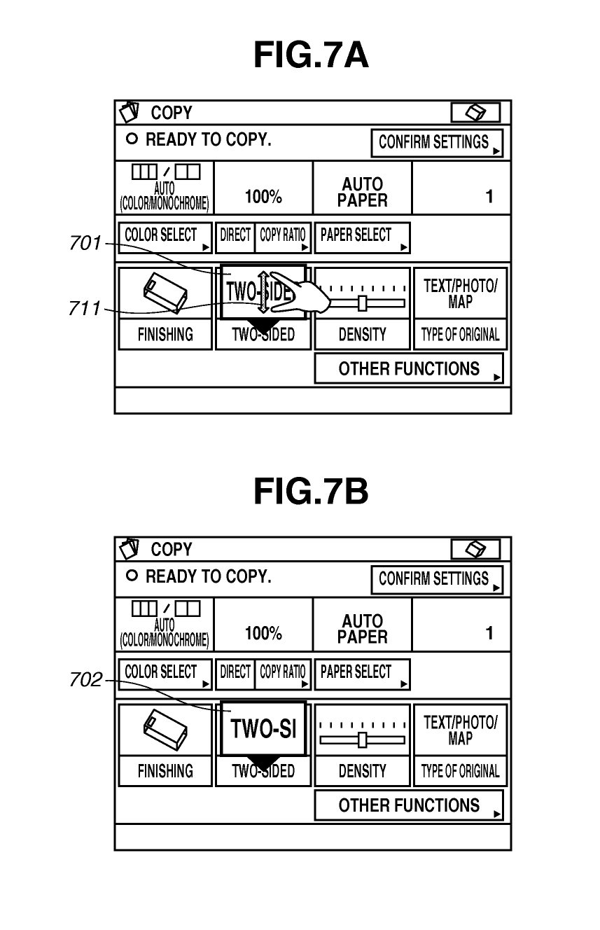

Next, examples of the magnifying glass displayed on the display 119 according to the above-described processing are described. FIG. 7A illustrates a state in which pinch 711 is performed inside a magnifying glass 701, in which a button image region containing letters “TWO-SIDED” is magnified and displayed. FIG. 7B illustrates a state in which the magnification ratio of the magnifying glass has been changed by the pinch 711 from the state illustrated in FIG. 7A, and the letters “TWO-SIDED” have been magnified. In FIG. 7B, a magnifying glass 702, in which the magnification ratio of screen information has been changed, is displayed.

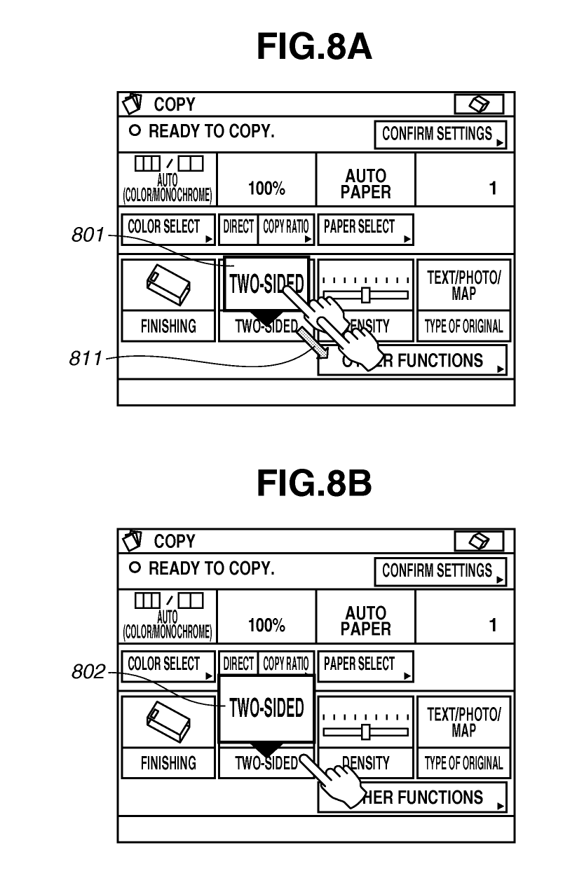

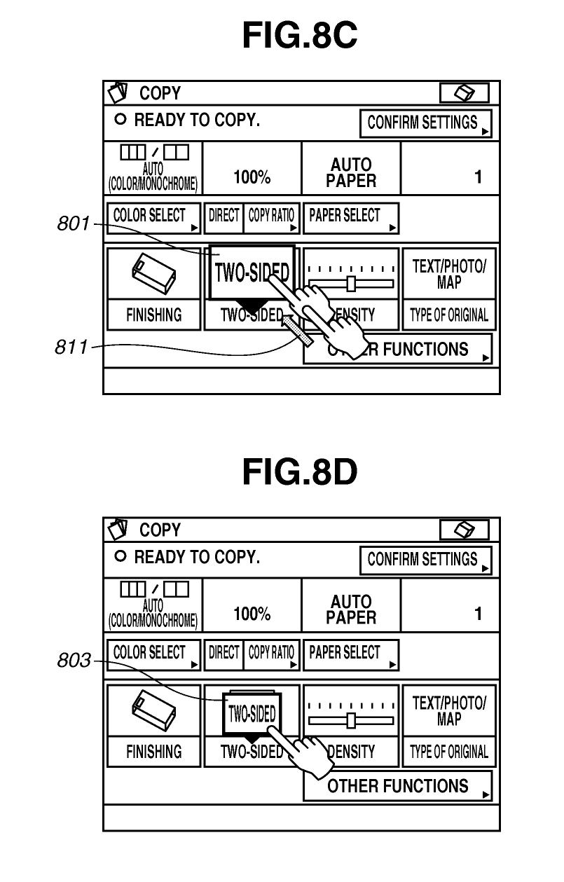

FIGS. 8A to 8D illustrate states in which the magnitude of the magnifying glass itself has been changed. FIG. 8A illustrates a state in which move 811 is being performed from the inside of a magnifying glass 801 toward a region other than the display region of the magnifying glass 801. FIG. 8B illustrates a state in which a magnifying glass 802, which has been magnified from the magnifying glass 801 according to such an operation illustrated in FIG. 8A, is displayed. FIG. 8C illustrates a state in which move 811 is being performed from the outside of the magnifying glass 801 to the inside thereof. FIG. 8D illustrates a state in which a magnifying glass 803, which has been reduced according to such an operation illustrated in FIG. 8C, is displayed.

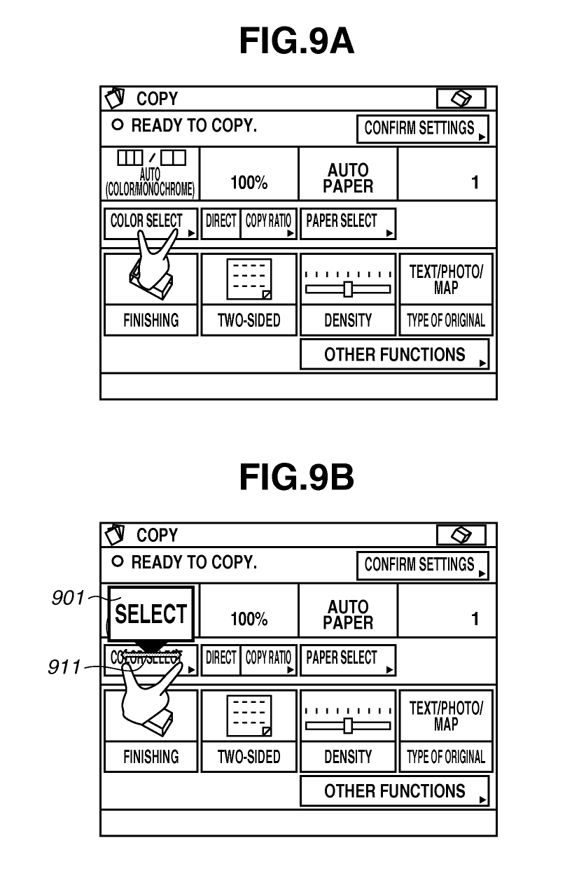

FIGS. 9A and 9B illustrate examples of changing of the magnifying glass when a multi-touch operation is performed. In the example illustrated in FIG. 9A, a character image region containing letters “COLOR SELECT” is specified as a display region, and the multi-touch operation is performed on the display region. In the example illustrated in FIG. 9B, a magnifying glass 901 is magnified and displayed according to the multi-touch operation 911.

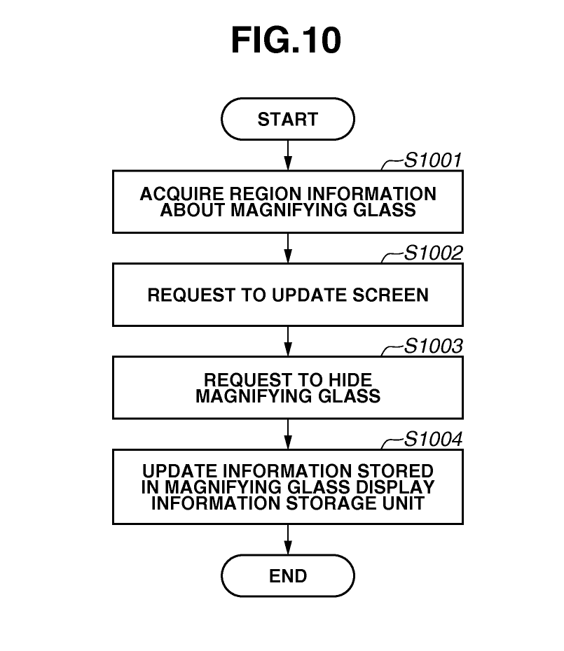

Next, magnifying glass hiding processing is described with reference to FIG. 10. This processing is also executed by the magnifying glass control unit 221. In step S1001, if the hiding condition is satisfied, the magnifying glass control unit 221 acquires information about regions of magnifying glasses from the magnifying glass display information storage unit 242. In step S1002, the magnifying glass control unit 221 requests the screen management unit 213 to update the screen in such a way as to hide the magnifying glass based on the acquired information about regions of magnifying glasses. In step S1003, the screen management unit 213, which has received such a request, causes the screen display unit 212 to hide the magnifying glass and to re-draw a display region, which has been covered over by the magnifying glass. This causes the screen display unit 212 to re-draw a screen of the display region, which has been displayed immediately before the magnifying glass is displayed, and to display the re-drawn screen on the display 119.

In step S1004, the magnifying glass control unit 221 determines that the magnifying glass is in the process of being hidden and updates the information of the visible state stored in the magnifying glass display information storage unit 242. Furthermore, the magnifying glass control unit 221 restores the value of the magnification ratio stored in the magnifying glass display information storage unit 242 to an initial value. Moreover, the magnifying glass control unit 221 restores the value of the magnitude stored in the magnifying glass display information storage unit 242 to an initial value.

In addition, the processing for restoring the value of the magnification ratio and the value of the magnitude of the magnifying glass to the respective initial values may be performed not only when the magnifying glass is hidden but also when the content displayed on the display 119 is changed. In other words, in the case of processing for repeating displaying and hiding of the magnifying glass in a case where the content displayed on the display 119 is the same, the magnifying glass may be displayed at the magnification ratio and the magnitude of the magnifying glass employed before the magnifying glass is hidden.

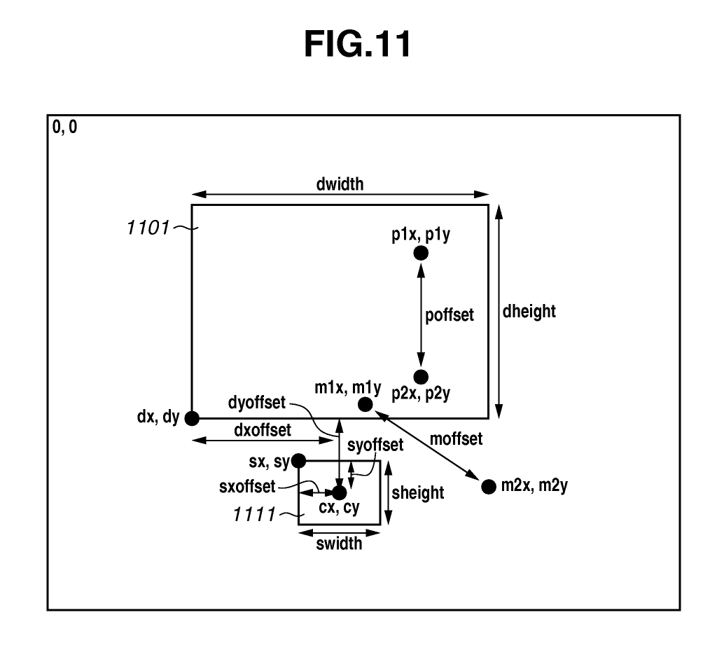

Next, the manner of calculating the size of the magnifying glass and a display region by the magnifying glass control unit 221 is described with reference to FIG. 11. FIG. 11 illustrates an example of a relationship between a display region 1111, which serves as a magnification source, and a magnifying glass 1101.

In the example illustrated in FIG. 11, suppose that the upper left corner of the screen is an origin (0, 0), and the horizontal direction and vertical direction are the x coordinate and y coordinate, respectively. Suppose that the center of the display region 1111 is at the coordinates (cx, cy), the distance from the center of the display region 1111 to a corner of the magnifying glass 1101 in the horizontal direction is dxoffset, and the distance from the center of the display region 1111 to a nearest side of the magnifying glass 1101 is dyoffset. Furthermore, suppose that the horizontal width and vertical width of the display region 1111 are swidth and sheight, respectively.

Furthermore, suppose that the x coordinate and y coordinate of the starting point of the display region 1111 are sx and sy, respectively, and the relative horizontal width and relative vertical width from the coordinates (cx, cy) to the coordinates (sx, sy) are sxoffset and syoffset, respectively.

Moreover, suppose that the x coordinate and y coordinate of the starting point of the magnifying glass 1101 are dx and dy, respectively, and the horizontal width and vertical width of the magnifying glass 1101 are dwidth and dheight, respectively. Suppose that the magnification ratio stored in the magnifying glass display information storage unit 242 is “r”. The magnification ratio “r” may be set to have different values for the respective x component and y component.

The magnifying glass control unit 221 calculates sx and sy, which are region information of the display region 1111, and dx and dy, which are region information of the magnifying glass 1101, as follows:

sx=cx−sxoffset

sy=cy−syoffset

dx=cx−dxoffset

dy=cy−dyoffset

Furthermore, the magnifying glass control unit 221 calculates the horizontal width dwidth and vertical width dheight of the magnifying glass 1101 using the magnification ratio “r” of screen information to be displayed in the magnifying glass 1101, as follows:

dwidth=swidth×r

dheight=sheight×r

In the case of changing of the magnitude of the magnifying glass itself due to move, suppose that the x coordinate and y coordinate of the operation position located before the start of move are m1x and m1y, respectively. Furthermore, suppose that the x coordinate and y coordinate of the operation position located after move are m2x and m2y, respectively. Suppose that the relative horizontal width from the x coordinate m1x to the x coordinate m2x is moffset.

The magnifying glass control unit 221 calculates a change ratio mr, which is used to change the magnitude of the magnifying glass itself, based on the above-mentioned calculated width moffset. For example, if the width moffset is equal to or greater than a predetermined value, the change ratio mr is set to a value equal to or greater than 1.0. If the width moffset is less than the predetermined value, the change ratio mr is set to a value less than 1.0.

The magnifying glass control unit 221 calculates the horizontal width dwidth′ and vertical width dheight′ of the magnifying glass, the magnitude of which has been changed due to move, as follows:

dwidth′=dwidth×mr

dheight′=dheight×mr

Additionally, the width moffset may be the relative vertical width from the y coordinate m1y to the y coordinate m2y.

In the case of changing of the magnification ratio due to pinch, suppose that the x coordinate and y coordinate of input information of each of two points due to pinch are (p1x, p1y) and (p2x, p2y), respectively. Furthermore, suppose that the relative vertical width from the y coordinate p1y to the y coordinate p2y is poffset. Then, the magnifying glass control unit 221 calculates a change ratio pr, which is used to change the magnification ratio “r”, based on the calculated width poffset. For example, if the width poffset is equal to or greater than a predetermined value, the change ratio pr is set to a value equal to or greater than 1.0. If the width poffset is less than the predetermined value, the change ratio pr is set to a value less than 1.0.

The magnifying glass control unit 221 calculates a magnification ratio r′ of screen information to be displayed in the magnifying glass 1101 as follows:

r′=r×pr

Additionally, the width poffset may be the relative horizontal width from the x coordinate p1x to the x coordinate p2x.

In the case of displaying of the magnifying glass due to pinch, suppose that the x coordinate and y coordinate of input information of each of two points due to pinch are (p1x, p1y) and (p2x, p2y), respectively. Furthermore, suppose that the relative vertical width from the y coordinate p1y to the y coordinate p2y is poffset. Then, the magnifying glass control unit 221 calculates a change ratio pr2, which is used to change the magnitude of the magnifying glass itself, based on the calculated width poffset. For example, if the width poffset is equal to or greater than a predetermined value, the change ratio pr2 is set to a value equal to or greater than 1.0. If the width poffset is less than the predetermined value, the change ratio pr2 is set to a value less than 1.0.

The magnifying glass control unit 221 calculates the horizontal width dwidth″ and vertical width dheight″ of the magnifying glass, the magnitude of which has been changed due to pinch, as follows:

dwidth″=dwidth×pr2

dheight″=dheight×pr2

Additionally, the width poffset may be the relative horizontal width from the x coordinate p1x to the x coordinate p2x.

In the above-described way, in the first exemplary embodiment, the magnifying glass can be operated according to the pinch or move operation by the user. This enables independently operating the displaying of a magnifying glass, the change of a magnification ratio, and the change of the magnitude of a magnifying glass itself, and also enables an intuitive and easy operation. Furthermore, in the respective operation instructions, an intuitive and immediate instruction due to the pinch or move operation can be performed, so that the visibility and operability in screen display can be improved.

Next, a second exemplary embodiment of the present disclosure is described. The second exemplary embodiment differs from the first exemplary embodiment in the manners of changing the magnitude of the magnifying glass and changing the magnification ratio in the magnifying glass. The second exemplary embodiment is described with a focus on points of difference from the first exemplary embodiment.

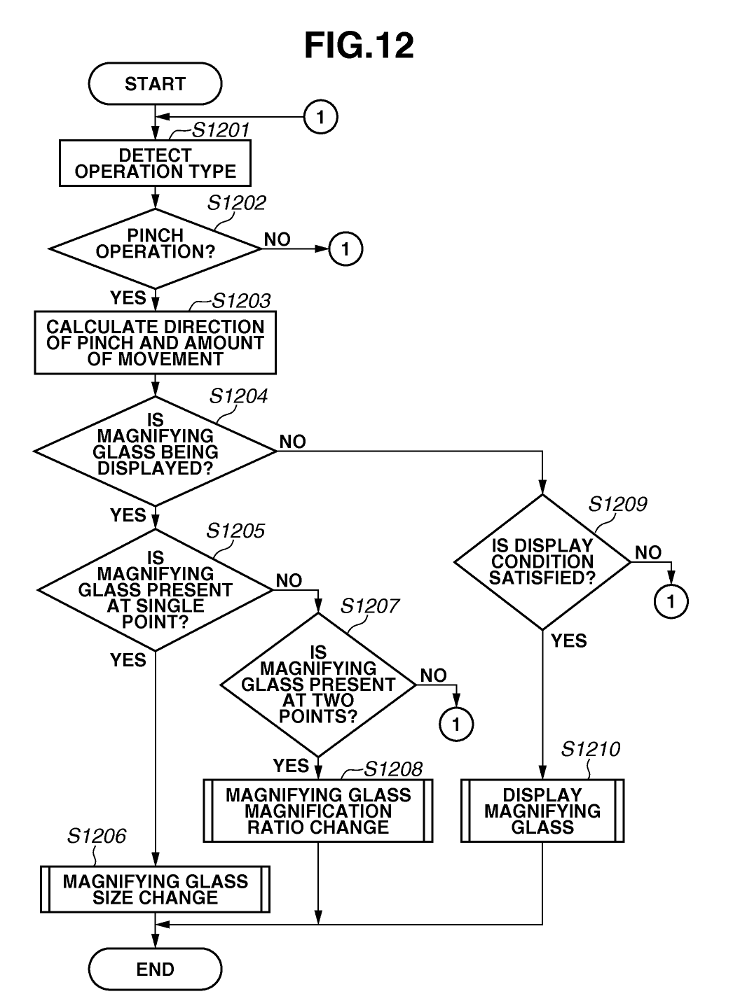

FIG. 12 is a flowchart illustrating a procedure of processing for changing the magnifying glass according to the second exemplary embodiment. This processing is executed by the magnifying glass control unit 221.

In step S1201, the magnifying glass control unit 221 monitors whether the operation type is pinch. If the operation type is not pinch (NO in step S1202), the processing returns to step S1201. If it is determined that the operation type is pinch (YES in step S1202), then in step S1203, the magnifying glass control unit 221 calculates the direction of pinch and the amount of movement thereof. Then, in step S1204, the magnifying glass control unit 221 determines whether a magnifying glass is being displayed by referring to information stored in the magnifying glass display information storage unit 242. If any magnifying glass is not being displayed (NO in step S1204), then in steps S1209 and S1210, the magnifying glass control unit 221 performs the same processing as that in steps S611 and S612 illustrated in FIG. 6. If a magnifying glass is being displayed (YES in step S1210), then in step S1205, the magnifying glass control unit 221 determines whether the magnifying glass is present at any one (single point) of two operation positions designated by pinch. The criterion for determining whether the magnifying glass is present is the same as that in the first exemplary embodiment. If the magnifying glass is present (YES in step S1205), the processing proceeds to magnifying glass size change processing (step S1206).

In the magnifying glass size change processing (step S1206), the magnifying glass control unit 221 calculates the size of the magnifying glass based on the direction of pinch and the amount of movement thereof, and stores the calculated size into the magnifying glass display information storage unit 242. Then, the magnifying glass control unit 221 requests the screen management unit 213 to update a screen regarding the magnifying glass based on information stored in the magnifying glass display information storage unit 242. Then, the processing ends.

If, in step S1205, it is determined that the magnifying glass is not present at a single point (NO in step S1205), then in step S1207, the magnifying glass control unit 221 determines whether the magnifying lens is present at two operation positions designated by pinch. In this regard, in the case of the first exemplary embodiment, the processing returns to input detection processing (NO in step S609 and step S601 illustrated in FIG. 6). If the magnifying lens is not present at the two operation positions (NO in step S1207), the processing returns to step S1201. If the magnifying lens is present at the two operation positions (YES in step S1207), the processing proceeds to magnifying glass magnification ratio change processing (step S1208).

In the magnifying glass magnification ratio change processing (step S1208), the magnifying glass control unit 221 calculates a magnification ratio based on the direction of pinch and the amount of movement thereof, and stores the calculated magnification ratio into the magnifying glass display information storage unit 242. Then, the magnifying glass control unit 221 requests the screen management unit 213 to update a screen regarding the magnifying glass based on information stored in the magnifying glass display information storage unit 242. Then, the processing ends.

In the above-described way, in the second exemplary embodiment, if at least one operation position of a plurality of simultaneously detected operation positions is located outside the magnifying glass, the magnifying glass control unit 221 changes the magnitude of the magnifying glass according to information about the movement of the other operation position. Furthermore, if all of a plurality of simultaneously detected operation positions are located inside the magnifying glass, the magnifying glass control unit 221 changes the magnification ratio of the magnifying glass according to information about the movement between the operation positions.

Therefore, similar to the case of the first exemplary embodiment, the second exemplary embodiment enables independently operating the change of a magnification ratio and the change of the magnitude of a magnifying glass itself, and also enables an intuitive and easy operation. Furthermore, the magnifying glass can be operated with an intuitive and immediate operation, so that the visibility and operability can be improved.

As described above, the information processing apparatus according to the present exemplary embodiment can perform an operation regarding a magnifying glass without switching display screens, and, therefore, does not require any setting operation in a setting screen, which may be required in conventional information processing apparatuses. Furthermore, the information processing apparatus according to the present exemplary embodiment allows an intuitive and immediate operation via a display screen, and, therefore, can improve the visibility and operability.

The units described throughout the present disclosure are exemplary and/or preferable modules for implementing the processes described in the present disclosure. The modules can be hardware units (such as a field programmable gate array, a digital signal processor, an application specific integrated circuit or the like) and/or software modules (such as a computer readable program). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure, as long as the technical solutions they constitute are complete and applicable.

Embodiments of the present disclosure can also be realized by a computer of a system or apparatus that reads out and executes computer executable instructions recorded on a storage medium (e.g., a non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2014-078211 filed Apr. 4, 2014, which is hereby incorporated by reference herein in its entirety.

What is claimed is:

1. An information processing apparatus comprising:
a detection unit configured to detect an operation position and an operation type of an operation performed in a display screen; and
a control unit configured to display a magnified display region, which is obtained by magnifying a predetermined display region containing the operation position, based on the operation position and the operation type detected by the detection unit, and to execute, without switching the display screen, a change of a magnitude of the magnified display region, which is being displayed, or a change of a magnification ratio of screen information displayed in the magnified display region.

2. The information processing apparatus according to claim 1, wherein the detection unit is configured to be able to simultaneously detect a plurality of operation positions of an operation performed in the display screen and to detect information about movement of the plurality of operation positions, and
wherein, if at least one operation position of the simultaneously detected plurality of operation positions is located inside the magnified display region, the control unit changes a magnification ratio of the magnified display region according to information about movement of another operation position of the simultaneously detected plurality of operation positions.

3. The information processing apparatus according to claim 2, wherein the control unit restores the changed magnification ratio to an initial value when the display screen is switched.

4. The information processing apparatus according to claim 1, wherein the detection unit is configured to be able to simultaneously detect a plurality of operation positions of an operation performed in the display screen and to detect information about movement of the plurality of operation positions,
wherein, if at least one operation position of the simultaneously detected plurality of operation positions is located outside the magnified display region, the control unit changes a magnitude of the magnified display region according to information about movement of another operation position of the simultaneously detected plurality of operation positions, and
wherein, if all of the simultaneously detected plurality of operation positions are located inside the magnified display region, the control unit changes a magnification ratio of the magnified display region according to information about movement between the simultaneously detected plurality of operation positions.

5. The information processing apparatus according to claim 4, wherein the control unit restores the changed magnification ratio to an initial value when the display screen is switched.

6. The information processing apparatus according to claim 1, wherein the control unit hides the magnified display region, which is being displayed, when the operation type of an operation performed on the display screen or the magnified display region satisfies a predetermined hiding condition.

7. The information processing apparatus according to claim 6, wherein, when hiding the magnified display region, the control unit displays a display screen, which has been displayed immediately before the magnified display region is displayed, at a foreground.

8. A control method for an information processing apparatus including a detection unit configured to detect an operation position and an operation type of an operation performed in a display screen, the control method comprising:
displaying a magnified display region, which is obtained by magnifying a predetermined display region containing the operation position, based on the operation position and the operation type detected by the detection unit; and
executing, without switching the display screen, a change of a magnitude of the magnified display region, which is being displayed, or a change of a magnification ratio of screen information displayed in the magnified display region.

9. A computer-readable storage medium storing a computer program that causes a computer to function as an information processing apparatus comprising:
a detection unit configured to detect an operation position and an operation type of an operation performed in a display screen; and
a control unit configured to display a magnified display region, which is obtained by magnifying a predetermined display region containing the operation position, based on the operation position and the operation type detected by the detection unit, and to execute, without switching the display screen, a change of a magnitude of the magnified display region, which is being displayed, or a change of a magnification ratio of screen information displayed in the magnified display region.
